(19) United States
(12) Patent Application Publication
(10) Pub. No.: US 2016/0220030 A1
(43) Pub. Date: Aug. 4, 2016

(54) Nontoxic Cushion Mat

(71) Applicants: Alex Xi Chenfu, Jersey City, NJ (US); Joo Young Chenfu, Jersey City, NJ (US)

(72) Inventors: Alex Xi Chenfu, Jersey City, NJ (US); Joo Young Chenfu, Jersey City, NJ (US)

(21) Appl. No.: 14/909,540

(22) PCT Filed: Apr. 7, 2015
(86) PCT No.: PCT/US15/24791

§ 371 Date: Feb. 2, 2016

Related U.S. Application Data
(60) Provisional application No. 61/976,307, filed on Apr. 7, 2014.

(51) Int. Cl. A47C 27/00; A47D 13/00; C08L 97/00; A47C 27/12

(52) U.S. Cl. CPC A47C 27/00; A47C 27/122; A47D 13/00; C08L 97/007

(57) ABSTRACT

This disclosure describes nontoxic cushion mats and methods of making and using them. Nontoxic CorkiBoo mixtures composed of cork granules and bamboo, cotton, or polyester fibers, and methods of making the mixtures are disclosed. Cushions mats are constructed using single layers of CorkiBoo mixtures, or multiple layers of cushion sheets composed of one or more types of cork granules, bamboo, cotton, or polyester fibers, CorkiBoo mixtures, or blends of them. The hardness level of each of the cushion layers is determined in advance. Covers can be used to enclose the cushions. The cushion mats can be modular or non-modular. For modular cushion mats, the modules can be connected using enclosing covers attached with snaps or hook-and-loop strips. Modules of the cushion mats can be used to assemble 3-dimensional polygons, which may be used as toys or temporary portable cribs.

### TECHNICAL FIELD AND BACKGROUND

This disclosure relates to the field of nontoxic cushion mats used generally to provide protective support or cover for human activities, such as play mats for young children, sitting mats for adults, cushioning mats for gymnastic sports, or covering mats for bedding. Cushion mats used for supportive and covering purposes share one salient characteristic.—They inevitably come into close, often direct, physical contact with users, including young children in the case of play mats or bedding mats, and therefore often raise safety and health concerns for users. An optimal mat, in terms of its safety and health features, is expected to be sufficiently strong and sturdy, such that they can endure the daily wears and tears; to be sufficiently soft and cushiony, such that users are safely protected from bumps and falls; to have surfaces that are sufficiently scratch-resistant and break-resistant, such that users do not accidentally inhale or ingest minute or small pieces of materials scratched or falling off from the surfaces of the mats; and to be made of materials that are nontoxic, by ingestion or inhalation.

Furthermore, it is desirable that an optimal cushion mat can be easily cleaned, for sanitation and hygiene, which also lengthens its useful life; can be assembled by modules, for easy transportation and storage, and to enable multiple geometrical and dimensional configurations of the modules for entertaining and educational purposes; is not too heavy, for increased portability; and is not too bulky or thick such that it will not pose as trip or fall hazards if the edges of the mat are exposed to open pathways when placed horizontally. Other beneficial qualities may also be desirable, such as being non-slippery, organic, naturally fire-retardant, or naturally antibacterial.

Cushion mats, particularly play mats for young children, have conventionally been made of EVA (Ethylene-vinyl acetate) foams, fabrics, fabrics with inside cushions made of polyester, cotton, or foams, and bare cork sheets without covers. EVA foam mats are the most popular and commercially successful, because EVA foams are sturdy, cushiony, not easily breakable, lightweight, flexible in geometrical shapes, non-slippery, and inexpensive. EVA foams, nonetheless, are known to potentially contain the chemical formamide, which in recent years has been found to be toxic, particularly to children. European Union, in a directive issued in 2009, significantly restricted the permissible contents of formamide in children's play mats, effective July 2013, after classifying formamide as CMR (carcinogenic, mutagenic or toxic for reproduction). (See, e.g., http://eur-lex.europa.eu/LexUriServ/LexUriServ.do?uri=OJ:L:2009:170:0001:0037:en:PDF for the EU directive restricting CMR contents in children toys, and http://www.phy.cam.ac.uk/internal_resources/hands/hazards/coshh/carcin2.pdf for a list of CMRs including formamide.) Even if other countries do not follow the footsteps of European Union in regulating formamide contents in play mats, concerns regarding toxicity of EVA foams will make it necessary to find a nontoxic alternative that can also satisfy the multitude of expected characteristics and desirable benefits.

Existing alternatives to EVA foams, even if nontoxic, have respective flaws that make it impractical or undesirable to use them to replace EVA foams. Fabrics, by themselves alone, are not rigid or cushiony enough to provide the desired protection and support. In the past, foams or polyesters have been used to make cushion sheets enclosed in fabric covers. Toxicity concerns, however, discourage the continued use of foams. Cottons can supposedly be used to make such cushion sheets, but such cushion mats would need to be impractically thick or heavy to be sufficiently cushiony, resulting in increased trip or fall hazard.

Cork sheets are another alternative to EVA foams. Although they provide more cushion than hard floors, cork sheets are generally 2-3 times harder than EVA foams. Consequently, compared with EVA foams, cork sheets are not sufficiently cushiony to provide the desired support.

### BRIEF DESCRIPTION OF THE DRAWINGS

FIG. 1: A 3-D view of a basic 3-layer cushion without covers.

FIG. 2: A 3-D view of a 5-layer cushion with inside and outside covers.

FIG. 3: A 3-D view of a single-layer cushion with inside and outside covers.

FIG. 4: A direct view of the bottom surfaces of a modular cushion mat consisting of 9 modules, connected with snaps and snap strips.

FIG. 5: A 3-D view of two mat modules, with their bottom surfaces facing upward, connected with base snaps and a connecting snap strip.

FIG. 6: A 3-D view of two mat modules, with their bottom surfaces facing upward, connected with 2 base hook-and-loop strips and a matching connecting hook-and-loop strip.

FIG. 7: A direct view of the bottom surface of a modular cushion mat consisting of 9 modules, connected with hook-and-loop strips.

FIG. 8: A 3-D view of two mat modules, with their bottom surfaces facing upward, connected with hook-and-loop strips attached to the vertical edges of the modules.

FIG. 9: A direct view of the bottom surfaces of a modular cushion mat consisting of 9 modules, connected with hook-and-loop strips attached to the vertical edges of the modules.

FIG. 10: A 3-D view of a cushion mat with an outside cover having an opening that can be closed by hook-and-loop strips attached to extensions of the top and bottom surfaces of the outside cover.

FIG. 11: A 3-D view of a rectangular prism constructed with 5 square mat modules, having one mat module at the bottom, and a hexagonal prism constructed with 6 square mat modules, having an empty bottom space.

FIG. 12: A 3-D view of a triangular prism constructed with 6 square mat modules.

### DETAILED DESCRIPTIONS

### A. Introduction

This disclosure describes cushion mats that can possess a satisfactory combination of the characteristics of being nontoxic, strong and sturdy, soft and cushiony, scratch- and break-resistant, easily cleanable, modular, lightweight, non-bulky, relatively thin, non-slippery, naturally fire-retardant, and naturally antibacterial. These cushion mats are constructed using single or multiple layers of cushion sheets, made of one or more types of natural cork sheets, cotton fibers, polyester fibers, natural bamboo fibers, mixtures of cork granules and bamboo, cotton or polyester fibers named “CorkiBoo” (described in Section B below), or blends of two or more of these materials. Methods of making CorkiBoo and such cushion mats are also disclosed.

### B. CorkiBoo

“CorkiBoo” is a group of compressed mixtures of two or more component materials having different levels of hardness. The harder component materials are composed primarily of cork granules, and the soft component materials are composed primarily of bamboo fibers. Cotton and polyester fibers can be used to replace bamboo fibers, or used in conjunction with bamboo fibers, as the soft component materials.

Natural cork granules are derived from barks of cork oak trees, normally left over from productions of wine stoppers. Cork productions are generally considered environmentally friendly and sustainable, because the cork oak trees are not harvested, only the barks. Some studies showed that cork granules could be fire-retardant and potentially antibacterial. Bamboo and cotton fibers are derived from natural bamboo trees and plants and cotton trees and plants, respectively. Bamboos, like corks, have been shown in some studies to also carry antibacterial properties. Polyester fibers can be made to be nontoxic and are typically derived synthetically.

Cork granules are much harder than bamboo, cotton, or polyester fibers. Because of the large differences in the levels of hardness between the two components, such mixtures allow one to flexibly adjust the levels of hardness of the mixtures by changing the relative proportions of the two components. Typically, for softer CorkiBoo mixtures, 30-70% by volume are cork granules, with the remaining materials comprising bamboo, cotton, or polyester fibers. For harder CorkiBoo mixtures, the percentage of cork granules can fall in the range of 71-90% by volume.

To manufacture CorkiBoo mixtures, cork granules and soft component materials, such as bamboo fibers, are first mixed in the desired percentage proportions. The mixture is then heated to a desired temperature range and compressed with a desired pressure range to generate the desired density. Binding materials, either commercially available or naturally derived, can also be added into the mixtures during the manufacturing process.

Since both cork granules and the soft component materials (bamboo or cotton fibers) can be nontoxic, lightweight, fire-retardant, and naturally antibacterial, CorkiBoo mixtures can also inherit these beneficial properties. Moreover, cushion sheets made of CorkiBoo mixtures are cushionier than bare cork sheets, but more rigid and sturdier than bamboo or cotton fiber battings alone. As a result, they can be used to construct single-layer cushions, with or without fabric covers, in addition to being used in multi-layered cushions for mats, as described in the sections below. Polyester can be used to replace or combine with bamboo or cotton fibers as the soft component materials.

### C. Single- Or Multi-Layered Cushions

Natural cork granules, bamboo fibers, cotton fibers, and polyester fibers have varying ranges of hardness. As described in Section B above, commercially available cork granules, bamboo fibers, and cotton fibers are derived from natural sources. Polyester fibers can be made nontoxic and are typically derived synthetically. Battings of bamboo, cotton, and polyester fibers are commercially available, most often for the making of quilts.

As described previously, for cushion mats, cork sheets made of cork granules are sturdy and strong, but too hard to provide sufficient protection against bumps and falls. Battings of bamboo, cotton, and polyester fibers, on the other hand, are soft and fibrous, and lack the rigidity and strength needed for support.

The nontoxic cushion mats described in this disclosure generally combine stacks of cushion sheets made of harder nontoxic materials, such as cork granules, with battings made of softer nontoxic materials, such as CorkiBoo mixtures, cotton fibers, polyester fibers, and bamboo fibers, or blends of two or more of them, in multiple layers. Each layer may be composed of one or more types of these nontoxic materials. Alternatively, the nontoxic cushion mats can use single cushion sheets made of CorkiBoo mixtures. In the case of multi-layered cushions, the resulting cushion mats inherit the rigidity of the harder sheets but are at the same time softer and cushionier because of the soft battings. The level of hardness and cushioning can be flexibly adjusted by varying the cushion layer thickness ratio, the number of layers, the materials used, and the configuration of the layers. In the case of single-layered cushions made of CorkiBoo mixtures, the levels of hardness and cushioning can be adjusted by varying the percentage ratio of the components used in making the CorkiBoo mixtures.

The cushion mats can be modular, where smaller component modules can be assembled into larger end configurations, or non-modular, where each of the mats comprises one single unit. The geometrical shapes of single-unit non-modular mats are generally more flexible, while the geometrical shapes of component modules for modular mats are generally limited to polygons having straight edges, such as squares, rectangles, or triangles, to facilitate easy connections between component modules.

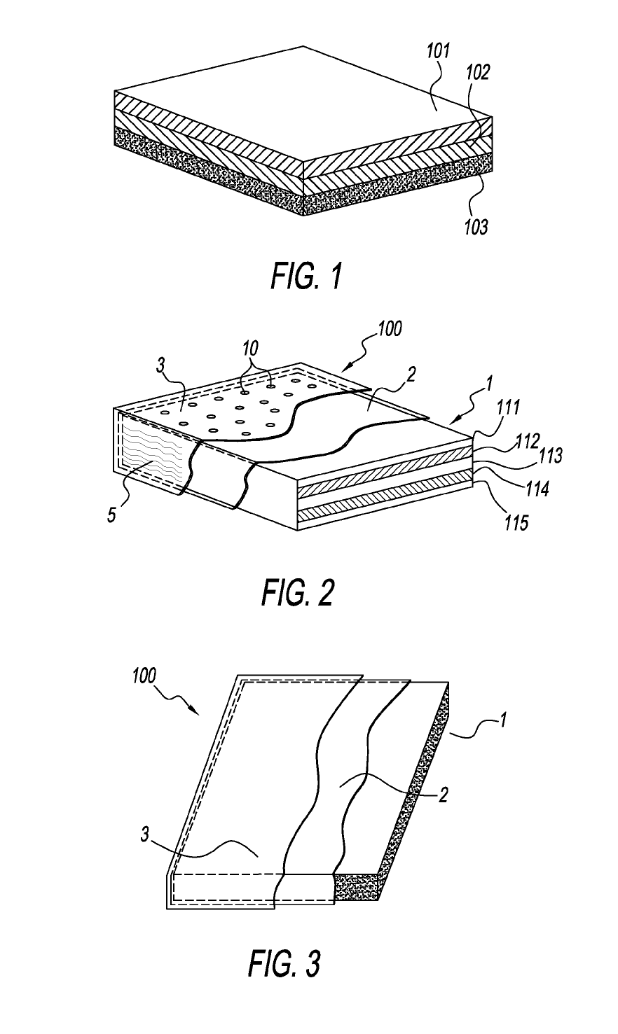

For example, referring to FIG. 1, for a basic three-layer cushion, harder cork sheets can be used as the top layer 101 and the bottom layer 103, with softer cotton batting as the middle layer 102. The middle batting layer 102 can also be made of bamboo fibers, cotton fibers, polyester fibers, CorkiBoo mixtures, or blends of two or more of them. The top layer 101 and the bottom layer 103 can also be made of CorkiBoo mixtures, if such CorkiBoo sheets are made hard and strong enough.

As another example, referring to FIG. 2, a five-layer cushion can comprise the following layers, in the order from top to bottom: (1) soft batting sheet 111; (2) hard cushion sheet 112; (3) soft batting sheet 113; (4) hard cushion sheet 114; and (5) soft batting sheet 115. The materials of the soft batting sheets can be variably selected from the options of cotton batting, polyester batting, bamboo batting, CorkiBoo batting, or blends of two or more of them, and need not be identical for all the three soft batting sheets. The hard cushion sheets can be made of materials variably selected from the options of cork sheets or CorkiBoo sheets.

As another example, referring to FIG. 3, a single-layer cushion is feasible by having one cushion layer 1 made of CorkiBoo mixtures that are manufactured to be sufficiently rigid and cushiony at the same time. It can be covered by an inside cover 2 and an outside cover 3 to form one module 100 of the cushion mats.

For multi-layered cushion mats, the layers of cushion sheets and battings can be bound together by organic glues, compressed lamination, tapes, enclosing wrappings, or enclosing covers. Glues can be feasible, but need to be able to be applied to soft batting layers. Compressed lamination without any enclosing cover can be suitable for multi-layer cushions, if the top and bottom layers are made of materials sufficiently hard, such as corks or CorkiBoo. The resulting cushion with lamination will be scratch-resistant and break-resistant. Commercially available fabric tapes or paper tapes can be applied, conventionally by thermal pressure for fabric tapes, to secure and bind the cushion layers. By themselves, however, tapes do not provide additional cushioning or protection to the cushions.

Enclosing wrappings can be used to bind and protect the cushions, although the wrappings typically do not have openings and thus lack the flexibility of being able to be removed for cleaning or replacement. Typically, the wrappings are made of soft non-fabric types of materials, such as cotton or bamboo fibers. The soft materials are made into wrapping sheets, which are wrapped around the cushion layers and then secured in place by commercially available fabric tapes. The cushion layers wrapped with the cotton wrapping sheets can then be inserted as a whole directly into one or more enclosing covers, if desirable.

Finally, enclosing covers, which typically have openings that allow them to be removed from the cushions for cleaning or replacement, can be used as a binding mechanism by themselves, but can additionally protect the cushions from wears and tears and provide extra cushioning support.

Such enclosing covers are typically made of fabrics, which provide several desirable benefits. Organic fabrics are readily available; they are easily cleanable by washing; they are lightweight; they are scratch-resistant and break-resistant; they can be made to nearly any shape or size; and they can be replaced economically.

Typically, referring to FIG. 2, bag-type covers 2 & 3 of fabrics are made to fit the sizes and shapes of the enclosed layered cushions. The fabrics may be pre-washed during the manufacturing process to prevent shrinkage due to subsequent washing when in actual use. A large enough opening on each of the covers allows the enclosed cushion to be inserted into or taken out of the cover. The opening can be closed by using one of the available conventional closing mechanisms, including snaps, zippers, sewing, and hook-and-loop strips, such as Velcro.

Continuing to refer to FIG. 2, it may be desirable to use two or more fabric covers, including minimally an inside one 2 and an outside one 3. The inside cover 2 serves primarily as a binding mechanism holding the layers together, but can be made of water-resistant or waterproof fabrics or fabric-like materials to protect the layered cushion from spills, drools, and other watery accidents. The outside cover 3, on the other hand, provides protective functions and can be easily removed and cleaned when necessary. Multiple fabric covers also increase the level of cushioning of the resulting mats. The two covers can be made of different materials to best fit their respective purposes.

Continuing to refer to FIG. 2, it is desirable for the outside cover 3 to tightly enclose the cushion layers 1, for otherwise, any shifting motions between the cover 3 and the cushion 1 can pose undesirable safety risks to users running, walking, or otherwise moving on top of the cushion mats. Such shifting motions can also make it more difficult and cumbersome to handle the cushion mats, such as for storage, reconfiguration, or transportation. To ensure tight fitting of the outside cover 3, it can be pre-washed to prevent post-manufacturing shrinkage, as described previously. Furthermore, the outside cover 3 can be made of elastic materials, such as knit fabrics, to ensure precise fitting. Compared with regular fabrics, elastic materials such as knit fabrics can be more expensive, more difficult to handle, and less appealing in appearance. It may be desirable, therefore, to use elastic materials only on the vertical surfaces 5 of the cushion mats, rather than on the top surface, the bottom surface, or the entire cover.

For modular cushion mats, each module is typically polygonal with straight edges, such as squares, rectangles, or triangles. When multiple modules are to be assembled, conventional zigzag types of connecting mechanisms (such as the formations used in products commercially available under the trademark Jigsaw Puzzle) can be used if the layered cushions are not enclosed in covers. The edges of a cushion are cut into zigzag formations such that the ridges on the edges of the cushion fit into the grooves on the matching edges of the opposing cushions.

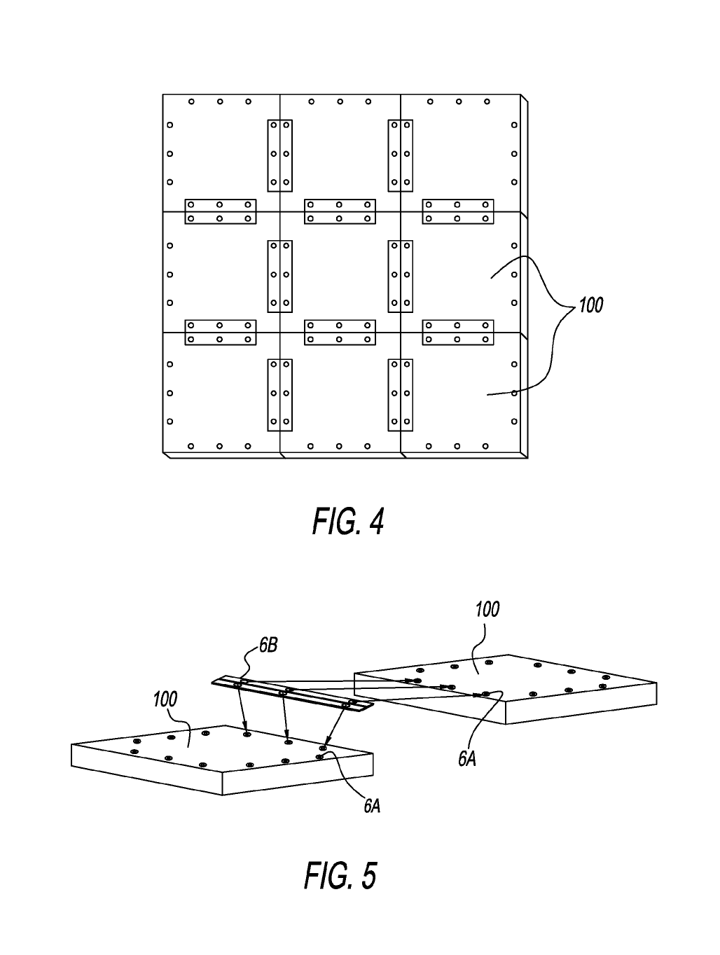

If covers are used, on the other hand, the modules can be connected by using snaps and snap strips or hook-and-loop strips (such as the ones commercially available under the trademark Velcro) attached onto the edges of the covers. In the case of snaps and snap strips, referring to FIGS. 4 and 5, one or more rows of base snaps 6A are attached onto the bottom surfaces of the edges of each module 100. Two modules can be connected on one side by connecting the one or more rows of base snaps on the modules with matching connecting snap strips 6B. Each of the connecting snap strips 6B comprises two rows of snap sub-strips linked together side by side, with each row of snap sub-strips capable of connecting to one row of the base snaps on one of the modules. The connecting snap strips 6B can be attached to or detached from the individual modules 100. In the case where the connecting snap strips 6B are attached to the modules, the base snaps and the connecting snap strips are typically each attached to two sides (out of a total of four sides, for rectangular or square modules) of each module 100.

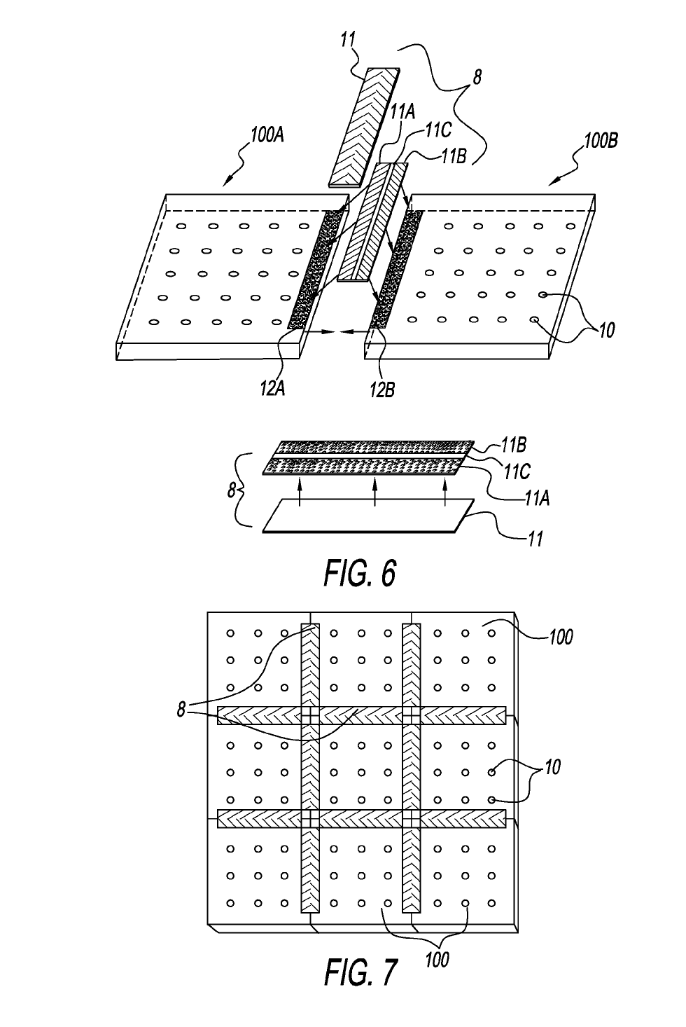

In the case of hook-and-loop strips, referring to FIGS. 6 and 7, one or more base hook-and-loop strips 12A & 12B are attached onto the bottom surfaces of the edges of each module. Two modules 100A & 100B can be connected side by side by attaching one of the two connecting hook-and-loop sub-strips 11A to the base hook-and-loop strip 12A on module 100A, and by attaching the other connecting hook-and-loop sub-strip 11B to the base hook-and-loop strip 12B on the other module 100B. Each of the connecting hook-and-loop strips 8 comprises two hook-and-loop sub-strips 11A & 11B fixated together side by side, with or without a gap 11C in between the sub-strips. The connecting hook-and-loop sub-strips 11A & 11B are configured, in terms of their sizes and strength, to be able to firmly attach to matching base hook-and-loop strips 12A & 12B. The connecting hook-and-loop strips 8 can be attached to or detached from the modules 100A and 100B.

Referring now to FIG. 6, a gap 11C between the sub-strips 11A & 11B can be desirable, because the positions where the base hook-and-loop strips 12A & 12B are attached to the modules, relative to the edges of the modules, may vary within a range among individual base hook-and-loop strips 12A & 12B. Such a gap 11C, therefore, allows the connecting hook-and-loop sub-strips 11A & 11B greater flexibilities to more closely match the varying positions of the base hook-and-loop strips 12A & 12B. To maintain such a gap 11C, two connecting hook-and-loop sub-strips 11A & 11B can be attached to a properly sized base sheet 11 with a gap 11C large enough to accommodate potential variations in the positions of the matching base hook-and-loop strips 12A & 12B.

As an example, continuing to refer to FIG. 6, where connecting hook-and-loop sub-strips 11A & 11B are about 1 inch wide, a gap 11C of about ¼-½ inch wide can be appropriate. Additionally, the base sheet 11 can be made of non-slip fabrics to prevent the mat from slipping on floors or any other surface.

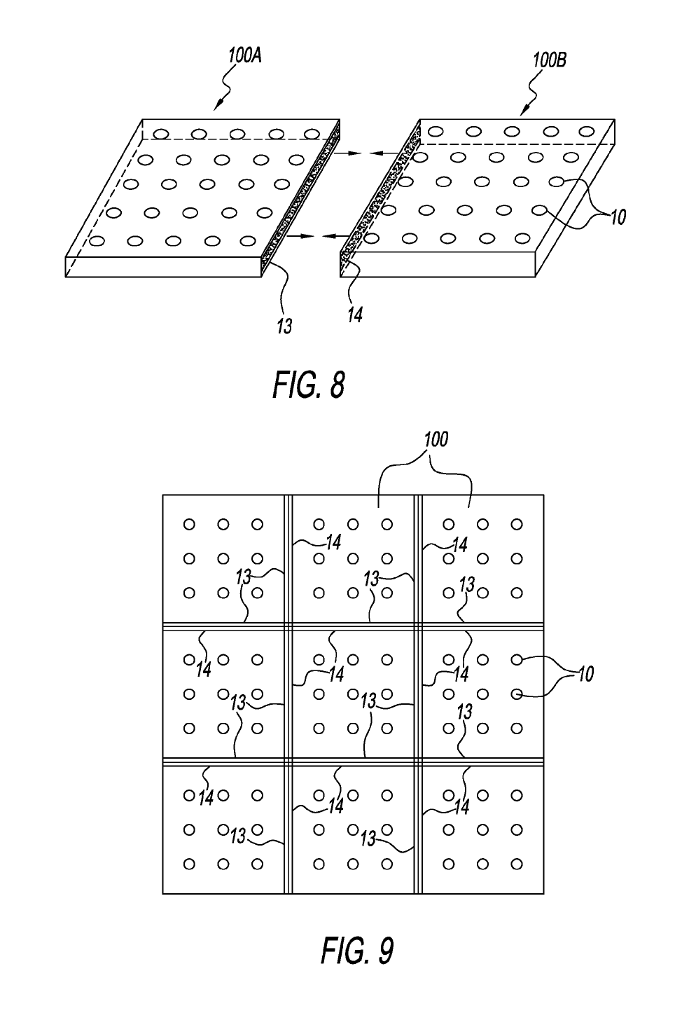

Typically, the snaps and strips (including base snaps, connecting snap strips, base hook-and-loop strips, or connecting hook-and-loop strips) are attached to the bottom surfaces of the modules, so that the top surfaces of the modules, with which the users make direct contact, remain flat and clear of obstructions. Alternatively, the snaps and strips can be attached to the vertical surfaces of the modules, particularly for hook-and-loop strips, which will also keep the top surfaces of the modules flat and clear of obstructions. As an example, referring to FIGS. 8 and 9, a hook-and-loop strip 13 is attached to the vertical surface of one module 100A, while a matching hook-and-loop strip 14 is attached to another module 100B. The two modules can be connected on the vertical surfaces having matching hook-and-loop strips by applying pressures parallel to the top and bottom surfaces of the modules and against each other. Referring to FIG. 9, multiple modules 100 can be connected together on the vertical surfaces using such vertical hook-and-loop strips 13 & 14, to form a large cushion mat.

Additionally, continuing to refer to FIG. 8, it can be desirable that the hook-and-loop strips 13 & 14 are made narrower than the width of the vertical surfaces where the strips 13 & 14 are attached. This is because when forces are applied on the top and bottom surfaces of the cushion mats, such as when users stand or sit on the top surfaces of cushion mats that are placed on the floors, the cushion mats may sink and decrease in thickness in response to the applied vertical forces. By making the strips 13 & 14 sufficiently narrower than the thickness of the modules 100A & 100B, the strips can be prevented from protruding out from the top surfaces of the modules 100A & 100B when vertical forces are applied to the modules 100A & 100B. As an example, if the cushion mats are about 1 inch thick, the strips can be made to be about ½ inch in width.

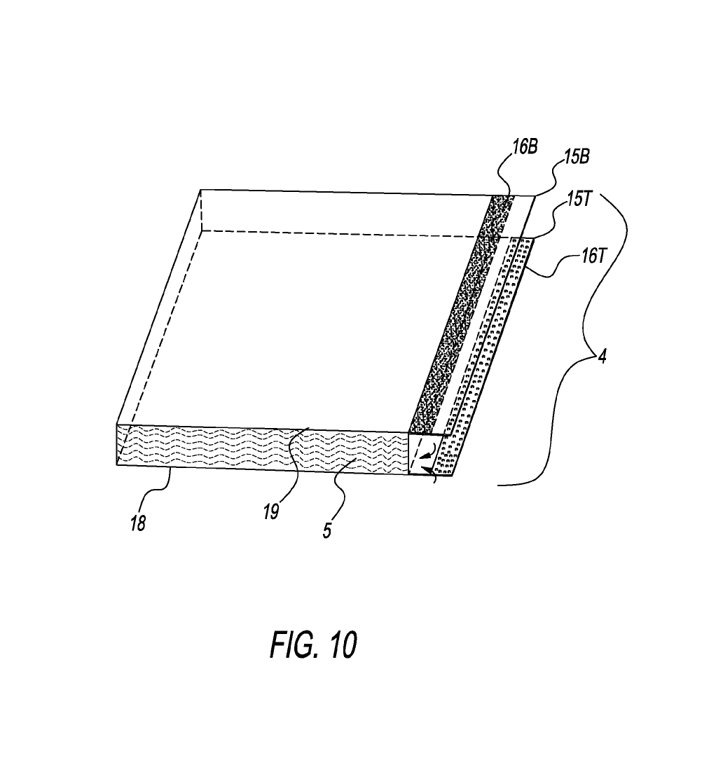

Referring to FIG. 10, the opening of an outside cover 4 of a cushion mat can be closed by hook-and-loop strips. On the outside cover, a top lid 15T extends from the top surface 18 of the cover, and a bottom lid 15B extends from the bottom surface 19 of the cover, each lid extending long enough to cover the opening 4 when folded toward the center of the opening 4. A hook-and-loop strip 16T is then attached onto one side of the top lid 15T, while another hook-and-loop strip 16B is attached onto the opposite side of the bottom lid 15B. As the top and bottom lids 15T & 15B are folded to cover the opening 4, the two hook-and-loop strips 16T & 16B can attach to each other under adequate pressure, and thus secure the closing of the outside cover. As described previously, it may be desirable for better fitting to use elastic materials, such as knit fabrics, on the vertical surfaces 5 of the outside cover. Such elastic materials may not be suitable on the particular vertical surface where the opening 4 is located, but may be used on the other vertical surfaces of the outside cover.

Similar to strips attached to vertical surfaces of cushion mats, continuing to refer to FIG. 10, it can be desirable that the hook-and-loop strips 16T & 16B are made narrower than the lids 15T & 15B, such that the strips 16T & 16B do not protrude out of the top surfaces of the cushion mats when the mats are subject to vertical forces. As an example, for cushion mats that are about 1 inch thick (where the lids 15T & 15B are each about the same width), the strips 16T & 16B may be made to about ½ inch in width.

Referring to FIGS. 2 and 6-9, anti-slip spots 10 can be built into the bottom surfaces of cushion layers, if uncovered, or of the outside covers, if covered, of the cushion mats to further enhance the stability of the cushion mats.

### D. Temporary Portable Crib

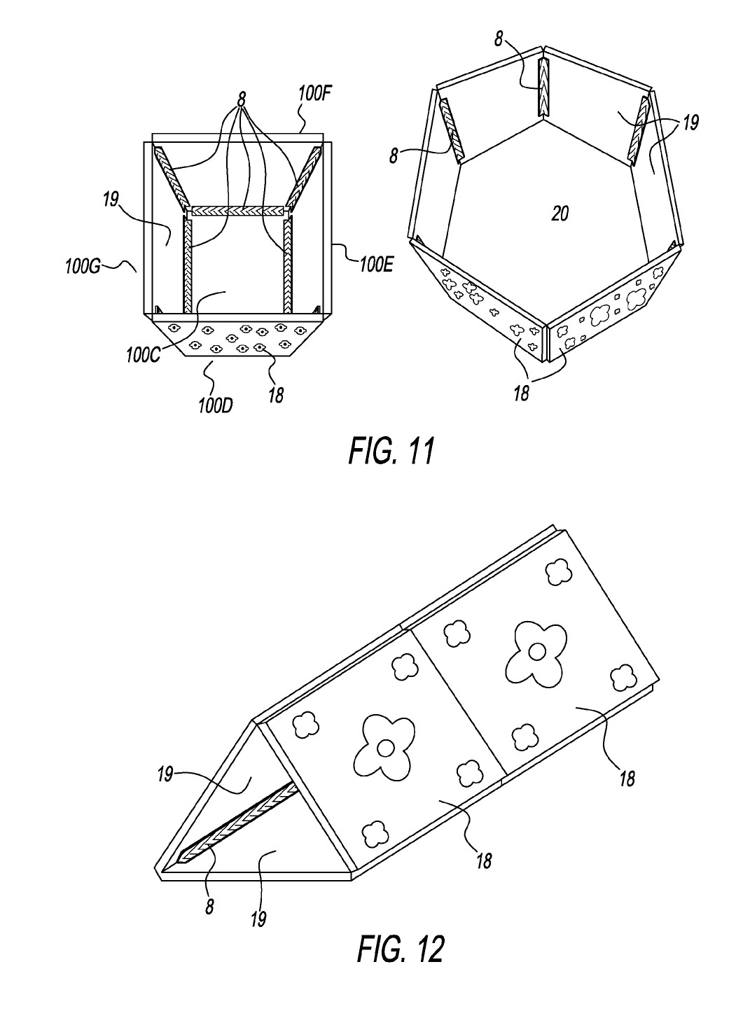

Using the connection mechanisms described above, modules of these nontoxic cushion mats can be connected not only into one single large mat, but also into various geometrical 3-D objects, such as polygonal or triangular prisms. As an example, referring to FIG. 11, five modules are connected to form a rectangular prism, with one module on the bottom of the prism, where the connecting strips 8 and the bottom surfaces 19 of the modules form the inside walls of the prism, with the top surfaces 18 of the modules facing outward. This configuration can be expanded to use two bottom modules and six vertical modules to form a longer rectangular prism with an open top. Continuing to refer to FIG. 11, six modules can be connected to form a hexagonal prism, where the bottom space 20 is left empty and the connecting strips 8 and the bottom surfaces 19 of the modules form the inside walls of the prism, with the top surfaces 18 of the modules facing outward. As another example, referring to FIG. 12, three or six modules can be connected to form a triangular prism, where the connecting strips 8 and the bottom surfaces 19 of the modules form the inside walls of the prism, with the top surfaces 18 of the modules facing outward.

These 3-D objects can be used for educational or entertaining purposes, but they can also be used as toy storage bins or temporary portable cribs for babies having problems falling into sleep. For such a baby, the parent typically needs to hold the baby for a long period of time before she is able to fall into sleep. The baby is then laid down slowly into a crib, but the detachment of the warm body of the parent and the simultaneous change into a sleeping posture tend to awaken the baby. Such a cycle may continue many times before the baby can finally fall into sleep in the crib. This vicious cycle, nonetheless, may be alleviated if the baby can be first placed into a sleeping posture while continuing to maintain full body contacts with the parent, which reduces the pace of environmental changes during the process of putting the baby into a crib.

Consequently, rather than placing the baby directly into a crib, the parent can first place the baby on one or more mat modules that are laid out horizontally. During this transition phase, the parent can continue to maintain full body contacts with the baby, because the vertical space surrounding the baby is not obstructed, unlike in a regular crib. This transition phase allows the baby to be placed in a flat sleeping posture without being awoken. In the next step, the parent can connect more modules vertically to the horizontal modules to form walls on the surfaces to enclose the baby and form a temporary crib. The baby can then be allowed to sleep in the temporary crib until she wakes up. Or this temporary crib can then be safely transported, with the baby inside, and placed into a regular crib, where the vertical side modules can be removed. The bottom modules can be removed at the same time, or at a later time when the baby is soundly asleep, without waking up the baby. Or, they can be left in the crib under the baby until she wakes up again.

### MODES FOR CARRYING OUT THE INVENTION

In a first embodiment, referring to FIG. 2, a modular nontoxic mat comprises modules 100 that further comprise polygonal, such as square, rectangular, or triangular, cushions 1, each of such cushions further comprising one or more layers of component cushion sheets. The one or more layers of component cushion sheets are bound together, when necessary, by organic glues, tapes, compressed lamination, enclosing wrappings, or one or more fabric enclosing covers. The one or more layers of component cushion sheets are composed of materials including cork granules, bamboo fibers, cotton fibers, polyester fibers, CorkiBoo mixtures, or blends of two or more of them. Referring now to FIGS. 4 through 10, each module connects to other modules by a connecting mechanism, including base snaps 6A and matching connecting snap strips 6B, and base hook-and-loop strips 12A & 12B and connecting hook-and-loop strips 8. If the modules are not enclosed in enclosing covers, then the modules can be connected by zigzag types of mechanisms. Each module ranges from ¼ inch to 1½ inch in thickness, with various surface area dimensions.

In a second embodiment, referring to FIGS. 1 and 2, each module 100 of the first embodiment is enclosed in an inside fabric cover 2 and an outside fabric cover 3. The enclosed cushion comprises three layers of square or rectangular component sheets, with the top layer 101 and the bottom layer 103 being cork granule sheets, and the middle layer 102 being a cotton batting sheet. Referring to FIGS. 4 and 5, each module connects to other modules by one or more rows of base snaps 6A attached onto the bottom of the edges of the outside fabric cover 3, and by matching connecting snap strips 6B. Each module 100 ranges from ¼ inch to 1½ inch in thickness, with various surface area dimensions.

In a third embodiment, referring to FIGS. 2, 6, and 7, each module 100 of the second embodiment connects to the other modules by one or more base hook-and-loop strips 12A & 12B attached to the bottom of the edges of the outside fabric cover 3 and by matching connecting hook-and-loop strips 8. In a forth embodiment, referring to FIGS. 8 and 9, any pair of modules 100A & 100B of the second embodiment are connected on the vertical surfaces with matching hook-and-loop strips 13 & 14 attached to the vertical surfaces, by applying pressures parallel to the top and bottom surfaces of the modules and against each other. The modules 100A & 100B are about 1 inch thick, and the hook-and-loop strips 13 & 14 are about ½ inch in width.

In a fifth embodiment, referring to FIGS. 2 and 10, the outside fabric cover 3 of each module 100 of the second embodiment comprises knit fabrics as the materials for three of the vertical surfaces 5 and further comprises an opening 4 on the one vertical surface not made of knit fabrics. The opening 4 is closed by a top lid 15T extending from the top surface 18 and having a hook-and-loop strip 16T attached to one side of the top lid 15T, and by a bottom lid 15B extending from the bottom surface 19 and having another hook-and-loop strip 16B attached to another side of the bottom lid 15B. As the top lid 15T and the bottom 15B fold to the center of the opening 4, the two hook-and-loop strips 16T & 16B connect with each other and secure the closing of the opening 4.

In a sixth embodiment, referring to FIG. 3, the enclosed cushion 1 of each module 100 of the second embodiment comprises one single layer of CorkiBoo sheet.

In a seventh embodiment, referring to FIG. 2, the enclosed cushion 1 of each module 100 of the fifth embodiment is wrapped in wrapping sheets made of cotton fibers and secured in place by commercially available fabric tapes, in addition to being enclosed in the inside cover 2 and the outside cover 3.

In an eighth embodiment, referring to FIG. 2, the enclosed cushion 1 of each module 100 of the second embodiment comprises five layers of square or rectangular component sheets, with the first layer 111, the third layer 113 and the fifth layer 115 counting from the top being composed of cotton battings, and the second layer 112 and the fourth layer 114 counting from the top being composed of CorkiBoo.

In a ninth embodiment, referring to FIG. 11, a temporary crib comprises at the bottom one or more modules of the mats of the second, the third, the fourth, or the fifth embodiments 100C, surrounded by at least four such square or rectangular modules 100D, 100E, 100F, & 100G placed vertically on the side of the bottom module to form an enclosed space above the bottom module and in between the side modules, and connected to one another by one or more base hook-and-loop strips attached onto the bottom surfaces near the edges of the outside fabric covers of the individual modules and by matching connecting hook-and-loop strips 8.

In a tenth embodiment, a method of forming a temporary crib comprises the steps of first laying a baby on one or more modules of the mat in the first embodiment placed horizontally, then surrounding the one or more bottom modules with at least four side modules placed vertically to form an enclosed space above the bottom module and in between the side modules, then transporting the temporary crib enclosing the baby to a regular crib, then placing the temporary crib inside the regular crib, and then removing the side modules and bottom modules.

The embodiments and examples disclosed in this disclosure are for demonstration and illustration purposes only, and do not and should not be construed to limit the scope of this disclosure to the embodiments and examples only.

1-13. (canceled)

14. A cushion mat, comprising one or more component modules, wherein each of the component modules comprises one or more component layers, wherein at least one of the component layers is composed of materials comprising cork granules and the hardness level of each of the one or more component layers is determined in advance, wherein each of the one or more component modules is enclosed in one or more layers of removable fabric cover, wherein the one or more layers of removable fabric cover comprise an outside cover and one or more layers of inside cover, wherein the outside cover comprises one or more openings sufficiently large to permit the ingress and egress of the enclosed component module and the one or more layers of inside cover, each of the one or more openings capable of being closed via one or more closing mechanisms, wherein the one or more closing mechanisms comprise one or more closing apparatuses comprising at least one apparatus type of sewing, zipper, snaps, or hook-and-loop strips, wherein the outside cover opening is positioned in a vertical opening side of the associated component module, and wherein each of the one or more closing apparatuses comprises a top lid extending outward along the top edge of the vertical opening side, a bottom lid extending outward along the bottom edge of the vertical opening side, a top hook-and-loop strip attached to one side of the top lid, and a bottom hook-and-loop strip attached to one side of the bottom lid, wherein the top lid and the bottom lid are capable of being folded toward the opening to close the opening by attaching the top hook-and-loop strip to the bottom hook-and-loop strip.

15. The cushion mat in claim 14, wherein the widths of the top hook-and-loop strip and the bottom hook-and-loop strip as measured vertically between the top edge and the bottom edge of the vertical opening side are 30%-70% of the width of the vertical opening side.

16-25. (canceled)
